(19) United States
(12) Patent Application Publication
(10) Pub. No.: US 2016/0151924 A1
(43) Pub. Date: Jun. 2, 2016

(54) RAZOR IN CUP-SHAPED CONFIGURATION

(71) Applicant: BEIERSDORF AG, Hamburg (DE)

(72) Inventors: Heinrich GERS-BARLAG, Kummerfeld (DE); Yvonne NEUMANN, Hamburg (DE)

(73) Assignee: BEIERSDORF AG, Hamburg (DE)

(21) Appl. No.: 14/905,036

(22) PCT Filed: Jul. 11, 2014
(86) PCT No.: PCT/EP2014/064935

§ 371 Date: Jan. 14, 2016

(30) Foreign Application Priority Data
Jul. 16, 2013 (DE) 102013213859.8

(51) Int. Cl. B26B 21/52; B26B 21/44; B26B 21/40

(52) U.S. Cl. CPC B26B 21/522; B26B 21/4068; B26B 21/443

(57) ABSTRACT

The invention relates to a razor, a razor set with a razor and a cup body and/or a pack of a personal care product, and a method for producing a razor. To make available an improved razor, a razor (1) has a handle body (10) with a lower face (11) for placing on the skin of a user, and with an upper face (12) which lies opposite the lower face and is placed in the hand of the user, and a blade head (20) with at least one razor blade (21), wherein the lower face has an oval shape, and the blade head is arranged, within the oval shape, at a tapering end, and wherein the upper face has a convex curvature.

The present invention relates to a razor, a razor set with a razor and a cup body and/or a pack of a personal care product and to a method for producing a razor.

In the sense of the present invention, shaving is understood as meaning cutting the hairs on the skin to just above the uppermost layer of skin with at least one blade. This does not involve removing the hair, just shortening it.

Known razors comprise an elongate handle part, which is connected to a blade head. During use as intended, the handle part lies in the hand of the user, in order to allow the blade head to glide over the user's skin.

Such razors are usually used for wet shaving, but it is also possible that a razor in the sense of the present application also has a power supply (for example a battery or rechargeable battery), which causes a vibration in the blade head in order to bring about a massaging effect and/or increase the closeness of the shave.

These razors are available as disposable articles, with permanently installed or exchangeable blade heads and a wide variety of blade head variations with different numbers of razor blades.

EP 615820 A2 describes a wet razor with a handle, on one end of which there is formed a razor head. In order to improve the ergonomic properties of a handle in the case of a wet razor and achieve the effect that the wet razor is guided more evenly and uniformly, the handle is curved in the direction pointing toward the surface to be shaved in the functional position.

EP 785851 A2 describes a wet razor with a substantially flat body element, which can be held with the palm of the hand and the fingers. The surfaces of the element are covered with materials that improve the handling, in particular the nonslip property.

DE 29503575 U describes a handle part for a razor which is provided at one end with a receiving device for a holder with blades arranged therein. The handle part is in this case configured as a leaf spring.

DE9015540U1 describes a wet razor with an exchangeable double blade, substantially consisting of a handle with a holding device for double blades, the blade holding device being integrated in the handle body.

FR1473527A describes a safety razor with a fixed blade, the razor consisting of a single piece of plastics material in a flat and elongate form, which has a transverse slot for receiving the fixed blade.

GB2452412A describes a shaving system with a bifurcated razor handle, which has a unitary plastics molding having a pair of hinges with elastomeric springs that are joined by a cartridge mounting portion which receives a flat multi-blade cartridge.

US2004143977A1 describes a single-use disposable shaving set composed of three component parts: a pressurized cartridge containing shaving foam sufficient for a single shave, a liquid cartridge containing aftershave liquid sufficient for a single shave, and a blade assembly having at least one blade, the cartridges forming the handle of the razor when they are mounted together and all three component parts forming the razor when they are mounted together.

US2013081289A1 describes a cartridge-biased handle having an elongate body, a head at a first end of the body, a pair of integral elastic arms extending outward from the head to a distal end, and a slot between the head and each arm.

U.S. pat. No. 4,044,463A describes a shaving apparatus comprising a holder which has at least one cutting element and a hair-pulling member, which has a blade-shaped molding which is movable between the inside and the outside of the holder.

An object of the invention is to provide an improved razor.

In one aspect, the invention relates to a razor with a handle body having a lower face for resting on the skin of a user and an upper face, opposite from the lower face, for lying in the hand of the user, and with a blade head having at least one razor blade, the lower face having an oval form and the blade head being arranged within the oval form at a tapering end, and the upper face being convexly curved.

The invention is based on the idea that a razor which consists of a handle body that is adapted substantially to the concavely curved palm of a hand and has a blade head integrated in it can be used ergonomically more satisfyingly and also more reliably for shaving. For this purpose, the handle body is formed in a way similar to a computer mouse, which makes very ergonomic handling possible. The handle body can be geometrically described as an ovoid, the lower face, which during use of the razor as intended glides along on the user's skin, being designed as substantially flat. The lower face describes in plan view an oval form, which may be of a symmetrical or asymmetrical design. The oval form of the lower face has a tapering end, at which the radius of curvature of the convex oval form is smallest and the tapering end consequently runs to a point in relation to the rest of the oval form. According to the invention, the blade head is arranged in the oval lower face. A razor according to the invention is therefore formed as a single, compact handle body of a substantially egg-shaped design (apart from the lower face, which is substantially flat), in the oval lower face of which the blade head is integrated.

Without departing from this basic idea, in embodiments of the razor according to the invention the lower face may have a concave curvature (indent into the interior of the handle body) and/or the upper face may have one or more smaller concave curvature(s), in order for example to provide individual fingers of the user with a suitable gripping surface (finger recess), in order to offer a better grip of the razor in the user's hand.

The upper face of the handle body (gripping surface) is formed in a curved manner, in order to be able to be held with the palm of a hand by means of a grasping grip. Preferably provided in the lower face of the handle body (skin resting side) is a clearance, in which the blade head, which has one or more razor blades, can be integrated with a form fit, the cutting-edge plane of the blade(s) being formed substantially in a plane with the skin resting side. The blade head or the blades thereof may be arranged in the lower face in a fixed or resilient manner or in a manner in which they can be tilted about their longitudinal axis, in order to make particularly reliable and safe shaving possible.

The gripping surface is that surface of the razor that is used by the user to hold and move the razor. The gripping surface that can be gripped with the hand is held by means of a grasping grip. The curvature of the upper face is adapted to a human hand, which makes ergonomic handling possible.

“Ergonomic” or “ergonomy” is to be understood as substantially meaning that the working conditions, the working sequence, the arrangement of an article to be gripped (here the device for shaving) are arranged in a spatially and temporally optimized way, and the working implements for a task are optimized in such a way that the result of the work is improved or optimized (qualitatively and commercially), and a user of the article is fatigued or even injured as little as possible.

A particular focus of the ergonomically advantageous razor is in this case on the user-friendliness, that is in particular improvement of the handling. Ergonomic products should be adapted to the body form of the user. Consequently, corresponding items of information concerning dimensions of the person are required for the development and assessment of products. “Anthropometry” refers here to the science of the relative dimensions of the human body and their exact determination. However, different people similarly have different body dimensions. It is not possible in practice to optimize every product for the individual person and his/her body dimensions. Therefore, the data of a relatively great number of persons must be compiled in percentiles. In the ergonomic assessment of a gripping surface, a distinction can be made between the classic method with a measuring tape and a set square and a method for determining the contact area between a hand and the gripping surface.

In particularly preferred embodiments, the razor according to the invention has an ovally round, tapering handle body, which increases the holding and gripping surface between the razor. and the hand. This makes shaving easier for the user.

On account of its compact, rounded wedge-like form, the handle body can be gripped with the entire hand. The blade unit is recessed in the preferably tapering end of the handle body and may consist of multiple blades, as well as balsam strips (care strips) with shaving soaps, emulsions and nourishing oils.

The surface of the handle body that is formed in a curved manner advantageously replicates a mirror image of the palm of a hand. It is correspondingly preferred that there are embodiments of the razor according to the invention that have different forms and sizes of the handle body, since the hands of users may be differently formed and of different sizes.

The—ergonomic- form of the upper face, curved according to the invention, enables the user to shave all parts of the body that are accessible with the hand. The user holds the device according to the invention like a piece of soap. The holding and moving of the razor according to the invention is similarly comparable to that of a computer mouse.

The form of the razor is improved in respect of being matched to the form of the palm of a hand. The “handling” of the razor is thereby completely changed in comparison with the razors that are provided with a conventional handle and makes a new, more satisfying shaving routine possible.

The razor according to the invention advantageously lies very well all around in the hand and adapts itself to different desired handling positions. The razor can moreover also be kept like a “piece of soap” on a “soap dish”, and thus fits in with the bathroom “scene”.

The blade head comprises one or more blade(s), the cutting edges of which form a plane. Advantageously, the blade head can be integrated with a form fit in the handle body and the cutting-edge plane of the blade(s) is formed in a plane with the skin resting side. During use of the razor as intended, the skin resting side is the lower face of the handle body, which may be designed as flat or slightly rounded. In a way similar to the way in which the upper face is formed as a mirror image of the palm of the user's hand, the lower face is formed as a mirror image of the surface of the skin of the region to be shaved of the user's skin. The blade head thereby lies substantially in the plane of the lower face, in order to make possible a smooth lower face of the razor that glides particularly satisfyingly over the skin. This also achieves the effect that there are no protruding blade edges or fastening elements that could disturb shaving.

Therefore, a razor of which the gripping surface between the razor and the hand is enhanced is provided according to the invention. This makes shaving easier for the user, since the ergonomic handle body lies particularly well in the hand and makes particularly safe handling of the razor possible. The razor is preferably provided with additional grip elements and concave grip elements, which prevent “slipping away” of the razor. Furthermore, the substantially flat and relatively large resting surface of the lower face on the skin offers certainty in preventing the blade head from skewing on the skin and injuring it. The razor according to the invention is outstandingly suitable for shaving part of or the whole body, and in particular for shaving under a shower.

In one embodiment, the handle body is formed as a convexly curved body, apart from the lower face. The handle body is preferably formed as a symmetrical or asymmetrical ovoid, or is egg-shaped, the lower face of which is formed as at least partially flat. It is advantageously achieved that the handle body is adapted particularly well to the palm of a user's hand and lies satisfyingly in his/her hand. This gives the handling a satisfactory feeling, and safety and reliability of the shave are increased.

In one embodiment, the lower face is formed as at least partially concavely curved. The particularly ergonomic form of the substantially convexly formed handle body can be enhanced by a concave indentation (curvature in the handle body) being incorporated on the lower face of the razor. This special form of the lower face enhances the grip of the thumb and fingers during shaving and increases the contact area between the razor and the hand.

In one embodiment, the upper face has grip elements for the nonslip holding of the handle body by the user. The handling of the razor and its hold in the hand of the user can be advantageously improved further by grip elements, such as for example roughened regions, a grooving, an adhesive surface, regions of nonslip material, being provided on the upper face (or else in an optional concave curvature of the lower face) and/or concave/convex curvatures being provided. “Slipping away” of the razor is thus advantageously prevented.

In one embodiment, the lower face and/or the upper face of the handle body has/have a recess, in which the blade head is arranged. The recess may reach through the handle body and thus form a hole in the upper face and the lower face, into which the blade head can be easily inserted and changed as and when required. In an alternative embodiment, only the lower face has the recess, which is designed to receive the blade head. In one embodiment, the blade head is detachably connected to the handle body.

In one embodiment, the blade head is arranged in the recess with a form fit. The form of the recess preferably corresponds substantially to the form of the blade head, the blade head is fixed in the recess by means of retaining elements, for example locked by means of latching elements. Bringing about the fixing of the blade head just by means of a form fit or simple retaining elements advantageously allows a planar lower face of the razor to be provided, which improves the handling and makes a satisfying shave possible.

In one embodiment, the lower face has a further recess (depression), which is arranged adjacent the recess in which the blade head can be arranged. Preferably, these two recesses form a common recess. A finger of the user for example may be inserted into the further recess, in order to detach the blade head from the recess and change it as and when required. Retaining elements could in this way be released particularly easily, and quick and simple changing of the blade head is achieved. The exchangeable blade head can thus be changed by a simple manipulation.

In one embodiment, the blade head is arranged on at least part of the lower face and at least part of the upper face. In such an embodiment, the blade head is arranged at a head end of the handle body. The blade head preferably forms the oval tip of the lower face of the razor.

In one embodiment, the razor also has a cap for covering the at least one razor blade. This preferably allows the razor blade(s) to be protected from damage, for example during transport, or prevents the razor blade(s) from causing damage. The cap preferably forms he oval tip of the lower face of the razor.

In one embodiment, the cap has at least one special blade on the outer side of the cap. The razor may advantageously be supplemented by one or more special blades. Thus, for example, the razor blades of the blade head may be suitable for shaving over a large area, which may be refined by the use of a smaller special blade arranged on the tip of the cap. Depending on requirements, different caps with different special blades may be arranged on the razor, whereby the applicational flexibility is advantageously increased.

In one embodiment, the blade head has a multiplicity of razor blades and at least one special blade. The blade head therefore preferably has regions of different types of blade, which makes an improved, more precise shave possible in different regions of the user's skin.

In one embodiment, the blade head has at least one balsam strip. A balsam strip in the sense of the present application may be a strip that comprises for example a shaving soap, a moisturiser, a soothing skincare product, an oil or the like. It is preferred to arrange the balsam strip adjacent the at least one razor blade and/or the at least one special razor blade. This advantageously achieves the effect that the skin is not only shaved but also treated and cared for by the balsam strip.

In a further aspect, the invention relates to a shaving set with a razor of the present invention and a cup body for receiving the razor in a form-fitting manner. Preferably, the razor can be kept like a “piece of soap” in a kind of soap dish, whereby the razor blades are advantageously protected. Furthermore, the razor integrates itself in the bathroom “scene” (like an airfreshener block), which is satisfying for the user.

In a further aspect, the invention relates to a shaving set with a razor of the present invention and a pack of a personal care product for receiving the razor in a form-fitting manner. It can advantageously be achieved that the razor can be kept wherever the shaving using the personal care product (for example shaving foam or gel and/or shower product) takes place. Thus, the user can transport the shaving set in a practical way without having to think about two separate products. Furthermore, the blades are advantageously protected, since they preferably lie against the pack. Furthermore, the user is reminded to get a new razor when the personal care product has been used up, since the amount of personal care product in the pack can be adapted to an average period of use of the razor.

In a further aspect, the invention relates to a method for producing a razor of the present invention, with the steps of: providing a handle body having an ovally formed lower face for resting on the skin of a user and a convexly curved upper face, opposite from the lower face, for lying in the hand of a user, providing a blade head having at least one razor blade, and arranging the blade head within the oval form of the lower face of the handle body.

The embodiments described above may be combined with one another and with the aspects described above as desired in order to achieve advantages according to the invention. Preferred combinations of embodiments are described below by way of example, while

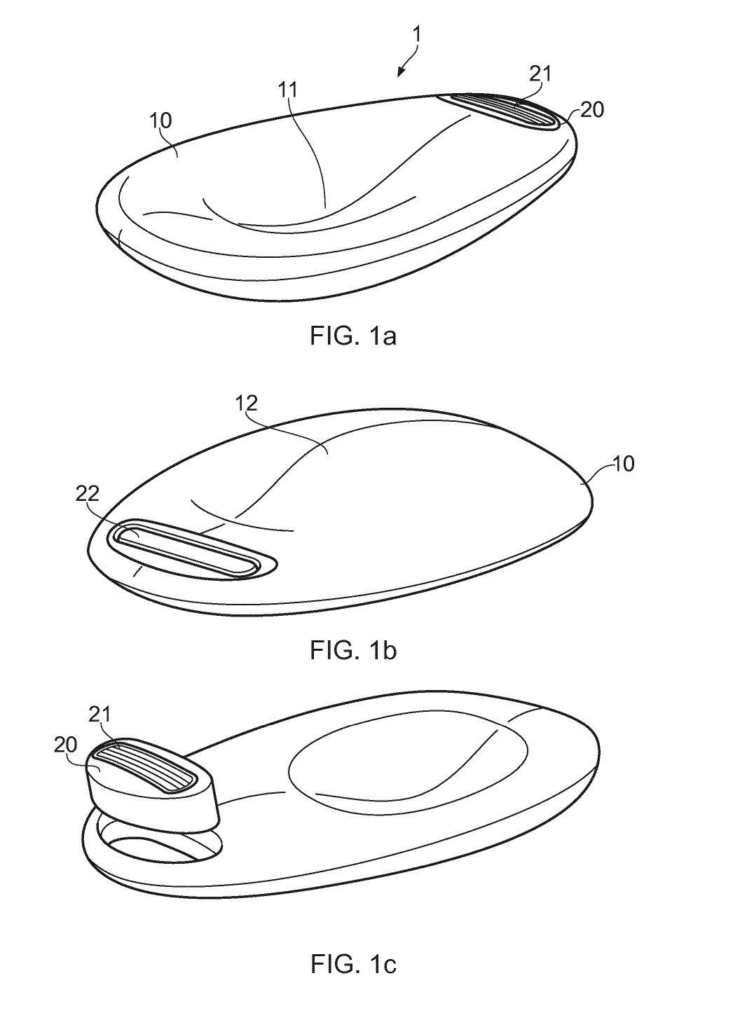

FIGS. 1a to 1c show an embodiment of a razor according to the invention;

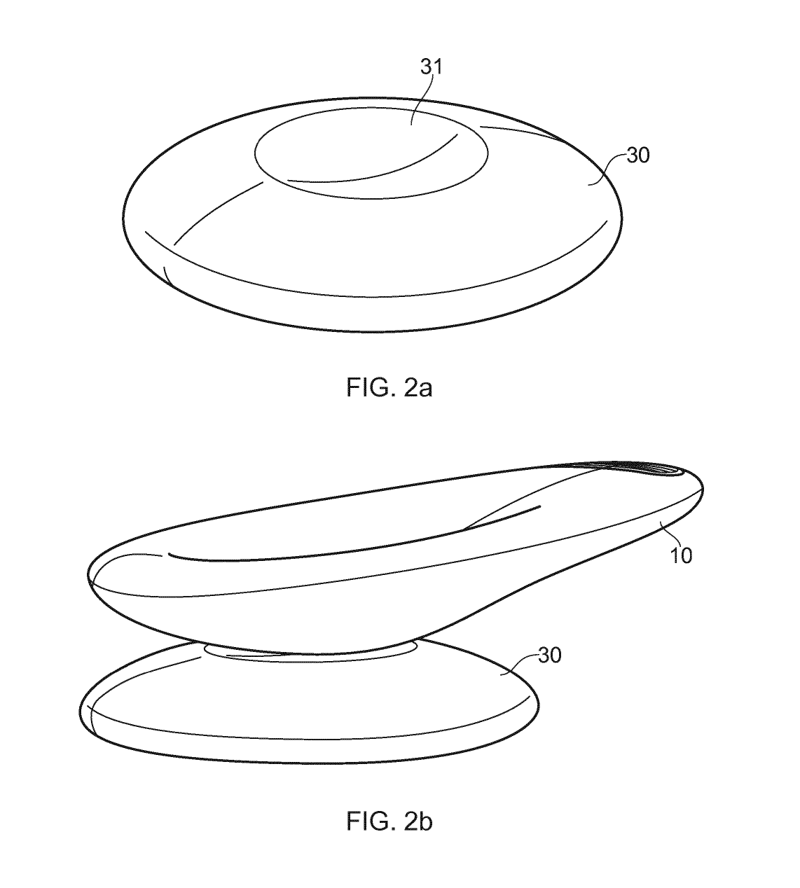

FIGS. 2a and 2b show an embodiment of a shaving set according to the invention;

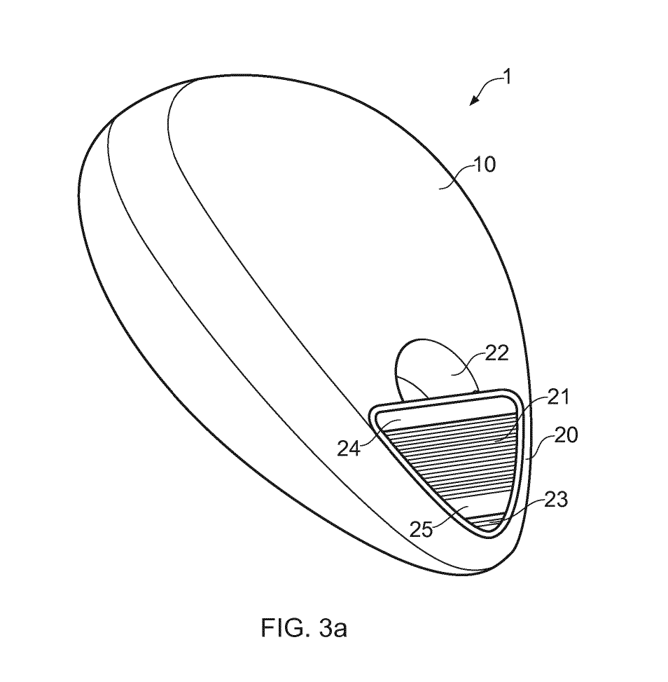

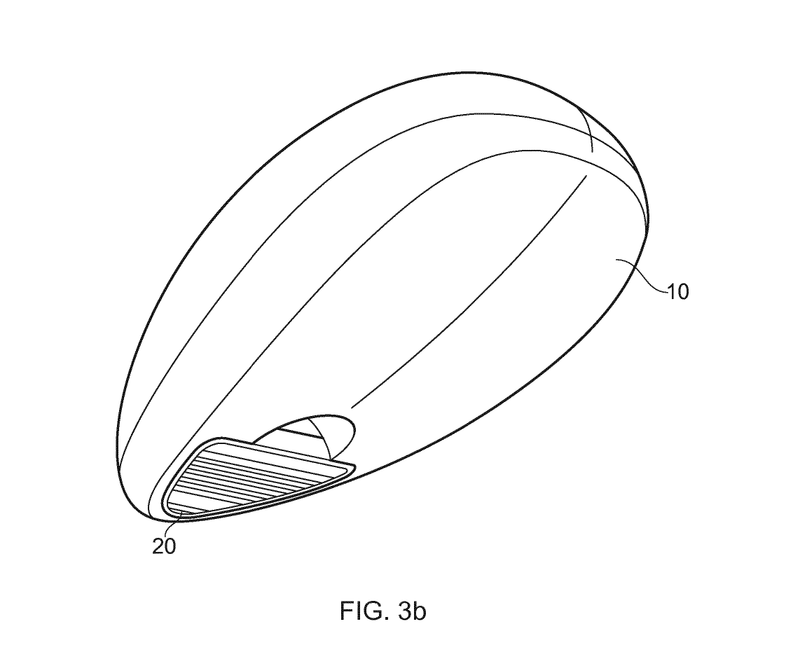

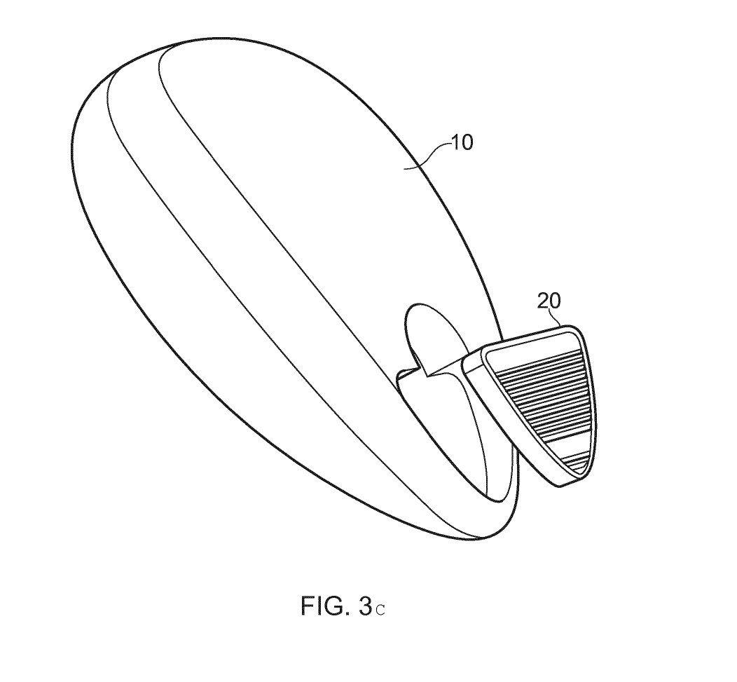

FIGS. 3a to 3c show a further embodiment of a razor according to the invention;

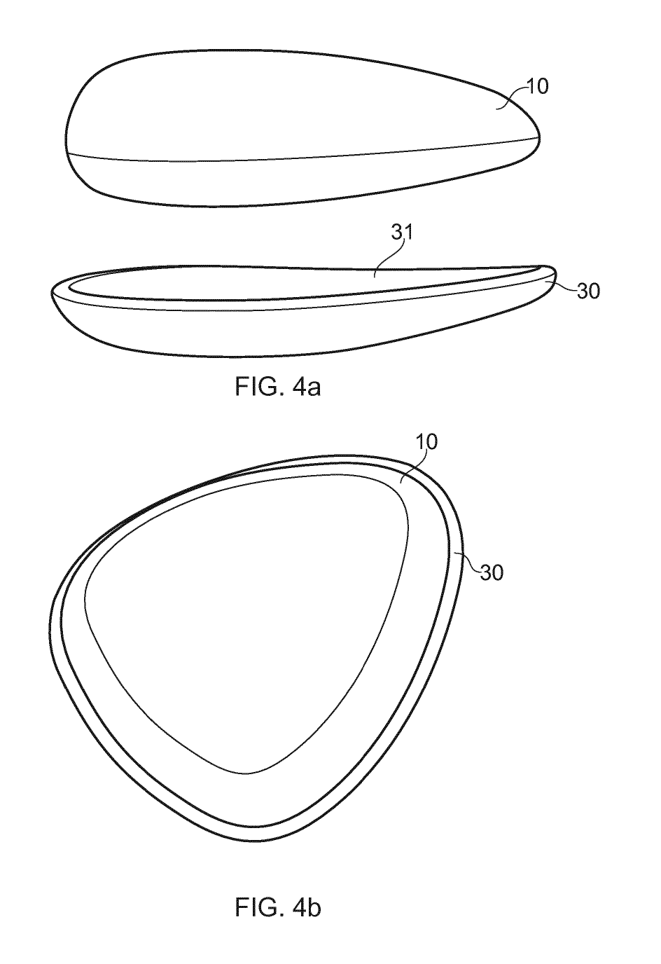

FIGS. 4a and 4b show a further embodiment of a shaving set according to the invention;

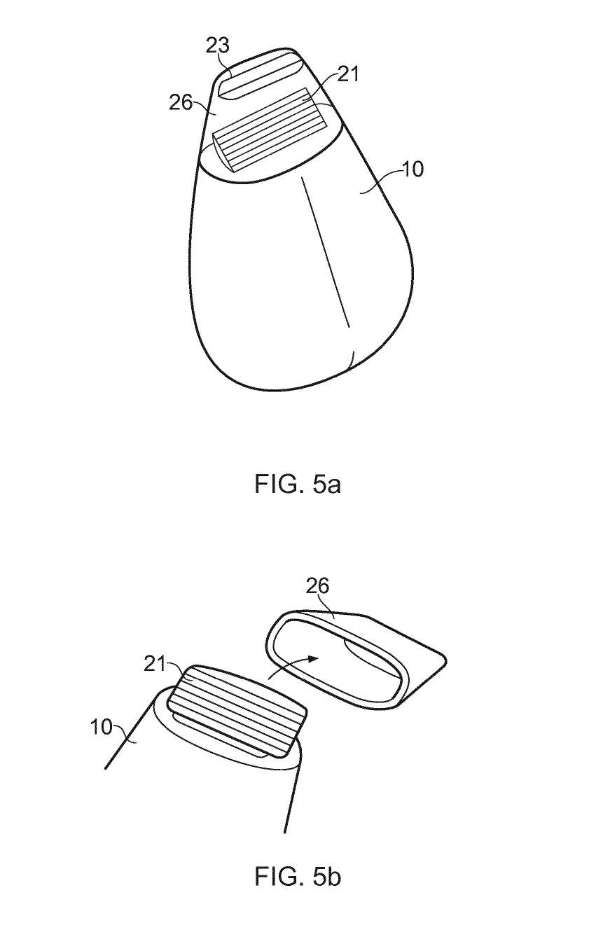

FIGS. 5a and 5b show a further embodiment of a razor according to the invention;

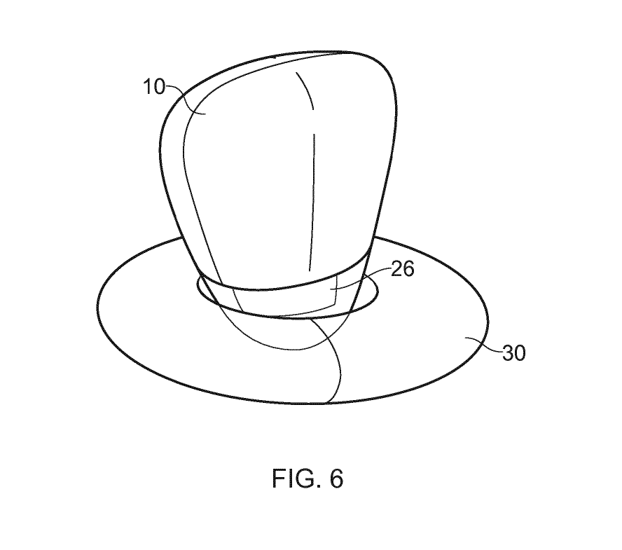

FIG. 6 shows a further embodiment of a shaving set according to the invention;

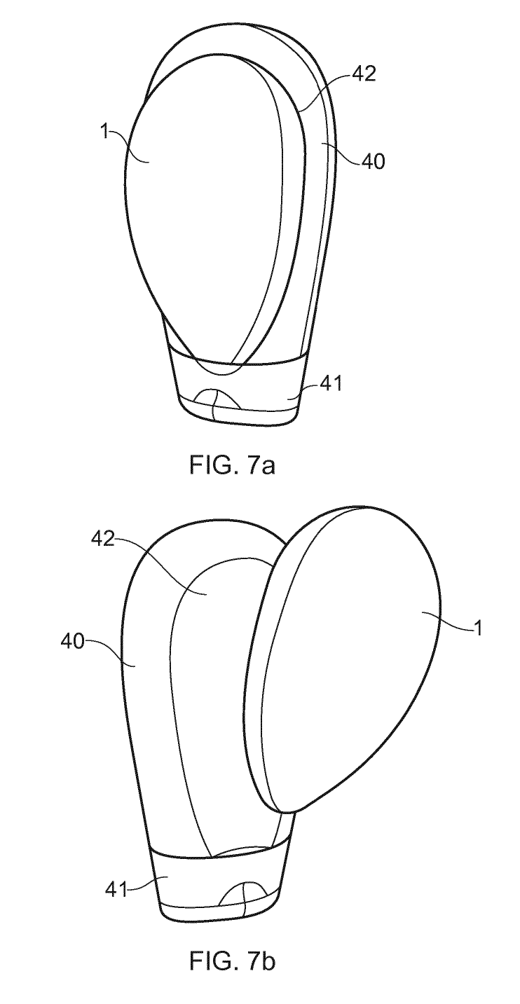

FIGS. 7a and 7b show a further embodiment of a shaving set according to the invention; and

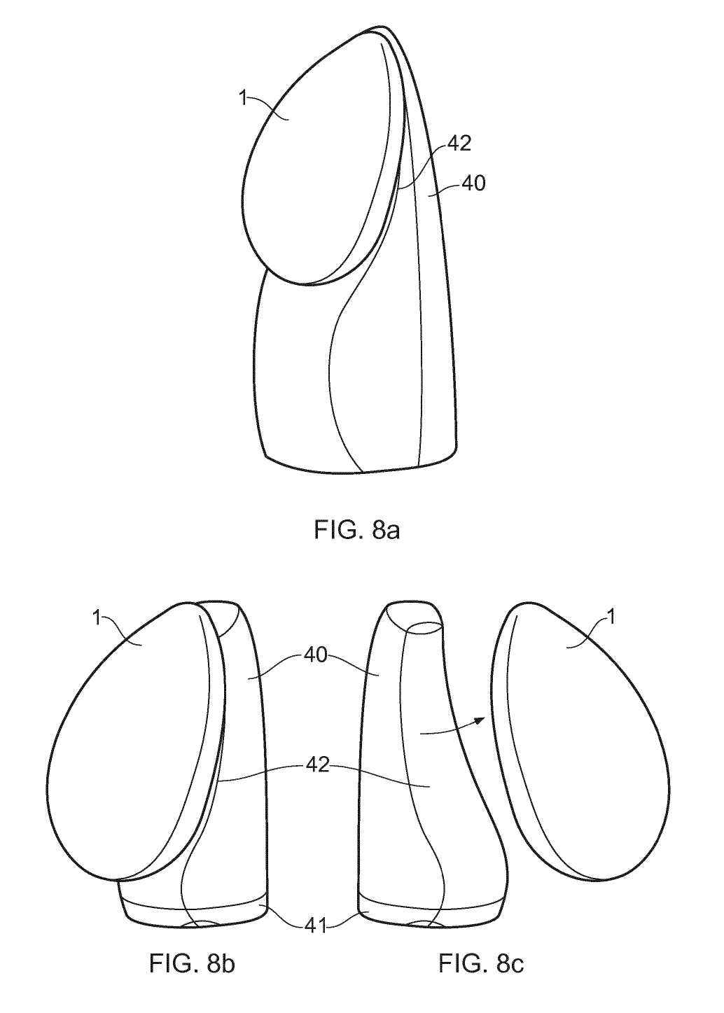

FIGS. 8a to 8c show a further embodiment of a shaving set according to the invention.

FIG. 1a shows a razor 1 from below, 1b from above and 1c from below (the razor 1 of FIG. 1a having been turned by 180°).

The razor 1 has a handle body 10 and a blade head 20. The handle body has a lower face 11 for resting on the skin of a user and an upper face 12, opposite from the lower face, for lying in the hand of the user. The blade head 20 has at least one razor blade 21. The lower face 11 has an oval form (in plan view) and the blade head 20 is arranged within this oval form. The upper face 12 is convexly curved.

The blade head 20 is arranged in a recess 22, which advantageously extends through the lower face 11 and the upper face 12. The blade head 20 can be locked in the recess 22 by means of retaining elements and can be detached from them in order to insert a new blade head 20, for example when the razor blades 21 have become blunt.

The lower face 11 advantageously has a concave curvature, in which the user can place his/her thumb in order to glide the razor 1 over the skin. Otherwise, the lower face 11 is configured as substantially planar. The rest of the handle body 10 is substantially convexly curved. The upper face 12 preferably has grip elements (not represented), which make nonslip holding of the handle body by the user possible.

On account of its compact, rounded form, the ergonomically ovoidally formed handle body 10 can be gripped with the entire hand. The blade head 20 is recessed in the handle body 10 at the tapering end and may have multiple blades 21, as well as balsam strips 24, 25 with emulsions and nourishing oils.

The particularly ergonomic form of the handle body 10 is enhanced in FIG. 1 by the fact that a concave indentation has been incorporated on the lower face 11 of the razor 1. This special form enhances the grip of the thumb and fingers during shaving and increases the contact area between the razor 1 and the hand.

The exchangeable blade head 20 can be replaced by a simple manipulation, for which purpose a recess 22 is incorporated in the handle body, exactly matching the form of the blade head 20 and optionally containing an additional indentation for swinging out the blade head 20.

The ovoidal handle body 10 increases the bonding and gripping surface between the razor and the hand. This makes shaving easier for the user, since the specially ergonomic gripping form of the handle body 10 with optional additional grip elements and concave grip elements prevents “slipping away” of the razor.

FIG. 2a shows a cup body 30 for receiving the razor 1 in a form-fitting manner. The cup body has for this purpose a depression 31, which is a mirror image of a subregion of the convexly formed upper face 12 of the razor. FIG. 2b shows how the handle body 10 is placed in the cup 31.

FIGS. 3 and 4 illustrate further embodiments of the razor 1 and the cup body 30. To the extent to which the features of the further embodiments coincide with those of the embodiments previously described, reference is made to the features described above.

The embodiment of FIG. 3 differs from the embodiment of FIG. 1 substantially in the design of the handle body 10, the recess 22 and the blade head 20, as explained below.

The handle body 10 of FIG. 3 is formed in a rounded wedge-like manner. Furthermore, the lower face 11 is formed as a planar surface. The form of the handle body 10 consequently resembles the form of a computer mouse.

The recess 22 is only provided in the lower face 11. It therefore does not form a through-hole between the lower face 11 and the upper face 12, as in FIG. 1. The recess 22 of FIG. 3 is not only designed to receive the blade head 22, but rather consists of two part-recesses: the one part is suitable for receiving the blade head 20, and the other part is suitable for receiving a finger of the user, which presses, prizes or similarly forces the blade head 20 out of the recess 20.

The blade head 20 not only has razor blades 21, but may additionally have a special blade 23, which may be used for fine shaving or for shaving particularly uneven portions of the skin. Also provided are balsam strips 24 and 25, which prepare the skin for shaving and care for it after shaving.

The embodiment of FIG. 4 differs from the embodiment of FIG. 2 substantially in the design of the cup body 30 and the cup 31. The cup 31 of FIG. 4 is designed for completely receiving the lower face 11 of the razor 1. The cup body 30 is formed by the wall of the cup 31.

FIGS. 5 and 6 illustrate further embodiments of the razor 1 and the cup body 30. To the extent to which the features of the further embodiments coincide with those of the embodiments previously described, reference is made to the features described above.

The embodiment of FIG. 5 differs from the embodiments of FIGS. 1 and 3 substantially in the design of the handle body 10 and the recess 22, as explained below.

The handle body 10 of FIG. 5 is formed in a rounded wedge-shaped manner both on the upper face 12 and on the lower face 11. The handle body 10 is formed as convexly curved both on the lower face 11 and on the upper face 12, in order to enhance ergonomic holding of the handle body. The razor 1 also has a cap 26 for the blade head 20. The handle body 10 and the cap 26 together form an ovoid (symmetrical or else asymmetrical), so that the cap 26 forms the oval tip of the lower face 11 of the razor 1. The blade head 20, which is covered by the cap 26, is consequently located in the oval form (in plan view) of the lower face 11,

The cap 26 has a special blade 23 at the tip, which can be used for shaving particularly uneven or small portions of the skin.

The recess 22 is provided in FIG. 5 both on the lower face 11 and on the upper face 12 (not represented in FIG. 5). The recess is provided on the end face of the handle body 10, which extends over the upper and lower faces 11, 12.

The embodiment of FIG. 6 differs from the embodiments of FIGS. 2 and 4 substantially in the design of the cup 30. The cup 30 of FIG. 6 is designed for receiving the cap 26 of the razor 1, and consequently the handle body 10.

FIGS. 7 and 8 show embodiments of shaving sets in which a razor 1 can be arranged with a form fit on a pack 40 of a personal hygiene product. The pack 40 has for this purpose a recess 42 on the broad side (FIG. 7) or narrow side (FIG. 8) of the pack 40. The fixing of the razor 1 on the pack 40 takes place in the embodiments of FIGS. 7 and 8 on the cover part 41 of the pack. Alternatively or in addition, however, other fixing elements, such as for example a Velcro strip, an adhesive strip, a clip element, a latching element or the like, may also be provided on the pack 40 and/or the razor 1.

### LIST OF REFERENCE NUMERALS

1. Razor
10 Handle body
11 Lower face
12 Upper face
20 Blade head
21 Razor blades
22 Recess
23 Special blade(s)
24 Balsam strip
25 Balsam strip
26 Cap
30 Cup body
31 Cup/depression
40 Pack
41 Cover part
42 Recess

1.-11. (canceled)

12. A razor, wherein the razor comprises a handle body having a lower face for resting on skin of a user and a convexly curved upper face, opposite from the lower face, for lying in a hand of the user, and a blade head comprising at least one razor blade, the lower face of the handle body having an oval form and the blade head being arranged within the oval form at a tapering end thereof.

13. The razor of claim 12, wherein the lower face and/or the upper face of the handle body comprises a recess in which the blade head is arranged.

14. The razor of claim 12, wherein apart from its lower face, the handle body is formed as a convexly curved body.

15. The razor of claim 14, wherein the lower face of the handle body is at least partially concavely curved.

16. The razor of claim 12, wherein the handle body represents an ovoid.

17. The razor of claim 12, wherein the upper face of the handle body comprises grip elements for nonslip holding of the handle body by the user.

18. The razor of claim 12, wherein the blade head is arranged on at least part of the lower face and at least part of the upper face of the handle body.

19. The razor of claim 13, wherein the blade head is arranged on at least part of the lower face and at least part of the upper face of the handle body.

20. The razor of claim 14, wherein the blade head is arranged on at least part of the lower face and at least part of the upper face of the handle body.

21. The razor of claim 15, wherein the blade head is arranged on at least part of the lower face and at least part of the upper face of the handle body.

22. The razor of claim 16, wherein the blade head is arranged on at least part of the lower face and at least part of the upper face of the handle body.

23. The razor of claim 17, wherein the blade head is arranged on at least part of the lower face and at least part of the upper face of the handle body.

24. The razor of claim 12, wherein the razor further comprise a cap for covering the at least one razor blade, the cap having at least one special blade on an outer side of the cap.

25. A shaving set, wherein the shaving set comprises the razor of claim 12 and a cup body for receiving the razor in a form-fitting manner.

26. A shaving set, wherein the shaving set comprises the razor of claim 12 and a pack of a personal care product for receiving the razor in a form-fitting manner.

27. A method for producing the razor of claim 12, wherein the method comprises:
providing a handle body having an ovally shaped lower face for resting on skin of a user and a convexly curved upper face for lying in a hand of the user,
providing a blade head comprising at least one razor blade, and
arranging the blade head within the oval form at a tapering end of the lower face of the handle body.
